(19) United States
(12) Patent Application Publication
(10) Pub. No.: US 2026/0221889 A1
(43) Pub. Date: Jul. 30, 2026

(54) METHOD FOR CONTROLLING POWER CONVERTER

(71) Applicant: Hitachi Energy Ltd, Zürich (CH)

(72) Inventors: ChunMing YUAN, Beijing (CN); Remo BAUMANN, Lenzburg (CH); Martin KLAEUSLER, Rombach (CH); Daniel SIEMASZKO, Ste-Croix (CH); Marko MOGOROVIC, Geneva (CH)

(73) Assignee: Hitachi Energy Ltd, Zürich (CH)

(21) Appl. No.: 19/146,556

(22) PCT Filed: Jan. 27, 2023
(86) PCT No.: PCT/EP2023/052059

§ 371 Date: Jul. 9, 2025

(30) Foreign Application Priority Data
Jan. 10, 2023 (CN) 202310036891.5

(51) Int. Cl. H02M 3/335; H02M 1/00; H02M 1/32

(52) U.S. Cl. CPC H02M 3/33584; H02M 1/0009; H02M 1/325; H02M 3/33573

(57) ABSTRACT

A controller for a dual active bridge (DAB) is disclosed. The controller includes a primary converter controller, configured to be coupled to a primary converter in the DAB and to control a duty cycle of the primary converter in the DAB based on a difference between a reference value and an output current of a secondary converter in the DAB.

### CROSS REFERENCE TO RELATED APPLICATIONS

This application is a 35 U.S.C. § 371 national stage application of PCT International Application No. PCT/EP2023/052059 filed on Jan. 27, 2023, which in turn claims foreign priority to Chinese Patent Application No. 202310036891.5, filed on Jan. 10, 2023, the disclosures and content of which are incorporated by reference herein in their entirety.

The present disclosure relates to a method for controlling a power converter and device and power system thereof, and in particular to a method for controlling a dual active bridge and device and power system thereof.

A solid-state transformer (SST) comprises a “bridge” of galvanic isolation to connect two electric powers, such as AC (alternating current) power to AC power, AC power to DC (direct current) power or DC power to DC power. In general, the SST connects a load in a LVDC (low volage DC) side. The SST can be applied, e.g., in a data centre, an EV (electric vehicle) charging station and so on.

FIGS. 1a to 1c depict three typical topologies of the DC to DC SSTs. The SSTs are constructed with several isolated DC/DC converters. These DC/DC converters joints input terminals and output terminals respectively by in-series connection or in-parallel connection. For example, the SST shown in FIG. 1a has input series (i.e., input terminals jointed by the in-series connection) and output parallel (ISOP). The SST shown in FIG. 1b has input series and output series (ISOS). The SST shown in FIG. 1c has input parallel and output parallel (IPOP).

In a modular structure of an SST, a dual active bridge (DAB) topology is commonly used as the cell topology. The DAB is an attractive choice due to its excellent variable-voltage control and easy parameter design. FIG. 2 shows a schematic diagram of a typical DAB topology with full-bridge two-level AC/DC converter comprising a primary AC/DC converter, a medium-frequency transformer (MFT), an inductor Lc and a secondary AC/DC converter. Note that the inductor Lc may be a stray inductance of the MFT.

In some cases, the SST may be required to provide an overcurrent output under certain critical situations. For example, the SST may be required to contribute a large overcurrent under an extremely low output LVDC voltage for a long period. Because of the long period, the output of the SST is required to be a steady-state output. For instance, the SST applied in the data centre may be required to provide the overcurrent during an LVDC short circuit fault, to trigger fuses or other protected actions for achieving the protection at the LVDC side. In addition, there may be similar requirements for the SST applied in the EV charging for an early phase of constant-current charging.

To provide such overcurrent, the SST controller may control the LVDC current (i.e., output current of LVDC side) in a target current value after the short-circuit fault happens. However, the short circuit fault results a large peak value of the LVDC current in the steady state and both the average and RMS (root mean square) value of the LVDC current are several times of those of the internal AC current of the MFT. In addition, diodes of the secondary AC/DC converter need to take responsibility for the large short-circuit current.

Under such conditions, the MFT design may be challenging. Because the internal AC current in steady state increases to over two times the nominal operation, the great peak current and RMS current result in high power losses and the requirements of large cooling capability for the MFT.

Furthermore, the LVDC output current in the steady state becomes several times higher than that in nominal operation. Such high current mostly flows through the freewheeling diodes of the secondary AC/DC converter. That is additional high-current diodes and cooling design are required for providing the overcurrent output.

In an aspect, the present disclosure relates to a first controller for a dual active bridge (DAB). The first controller comprises a primary converter controller, configured to control a duty cycle of be coupled to a primary converter in the DAB and to control a duty cycle of the primary converter in the DAB based on a difference between a reference value and an output current of a secondary converter in the DAB.

In another aspect, the present disclosure relates to a converter device. The converter device comprises:
a dual active bridge (DAB) comprising a primary converter, a transformer and a secondary converter, and
a controller according to the aforementioned first controller.

In still another aspect, the present disclosure relates to a method for use in a controller. The method comprises controlling a duty cycle of the primary converter in a dual active bridge (DAB) based on a difference between a reference value and an output current of a secondary converter in the DAB.

In an aspect, the present disclosure relates to a second controller for a DAB. The second controller comprises a secondary converter controller, configured to be coupled to a secondary converter in the DAB and to control a duty cycle of the secondary converter in the DAB based on a difference between a reference value and an input current of a primary converter in the DAB.

Various exemplary embodiments of the present disclosure are directed to providing features that will become readily apparent by reference to the following description when taken in conjunction with the accompanying drawings. In accordance with various embodiments, exemplary systems, methods, and devices are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

In the following, exemplary embodiments of the present disclosure will be described. It is noted that some aspects of any one of the described embodiments may also be found in some other embodiments unless otherwise stated or obvious. However, for increased intelligibility, each aspect will only be described in detail when first mentioned and any repeated description of the same aspect will be omitted.

The above and other aspects and their implementations are described in greater detail in the drawings, the descriptions, and the claims.

### BRIEF DESCRIPTION OF THE DRAWINGS

FIGS. 1a to 1c illustrate three typical topologies of the DC to DC SSTs.

FIG. 2 illustrates a schematic diagram of a typical DAB topology.

FIG. 3 illustrates a schematic diagram of a converter device according to an embodiment of the present disclosure.

FIG. 4 shows a schematic diagram of a primary converter controller according to an embodiment of the present disclosure.

FIG. 5 shows a schematic diagram of signals according to an embodiment of the present disclosure.

FIG. 6 shows a schematic diagram of a primary converter controller according to an embodiment of the present disclosure.

FIGS. 7a and 7b show a schematic diagram of the secondary converter according to an embodiment of the present disclosure.

FIG. 8 shows a schematic diagram of a secondary converter controller according to an embodiment of the present disclosure.

FIG. 9 illustrates a schematic diagram of a converter device according to an embodiment of the present disclosure.

FIG. 10 illustrates a flowchart of a method according to an embodiment of the present disclosure.

FIG. 11 illustrates a flowchart of a method according to an embodiment of the present disclosure.

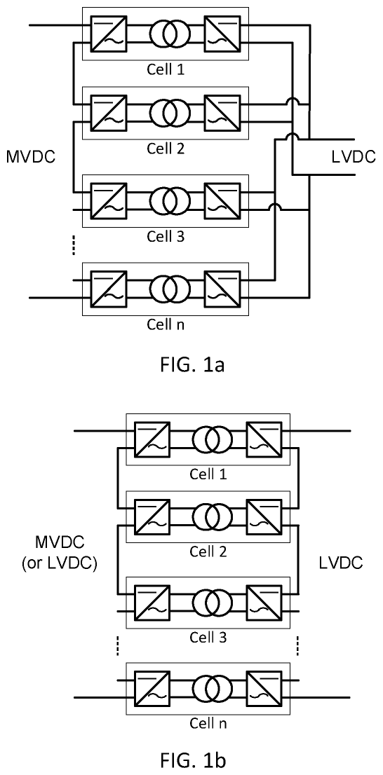

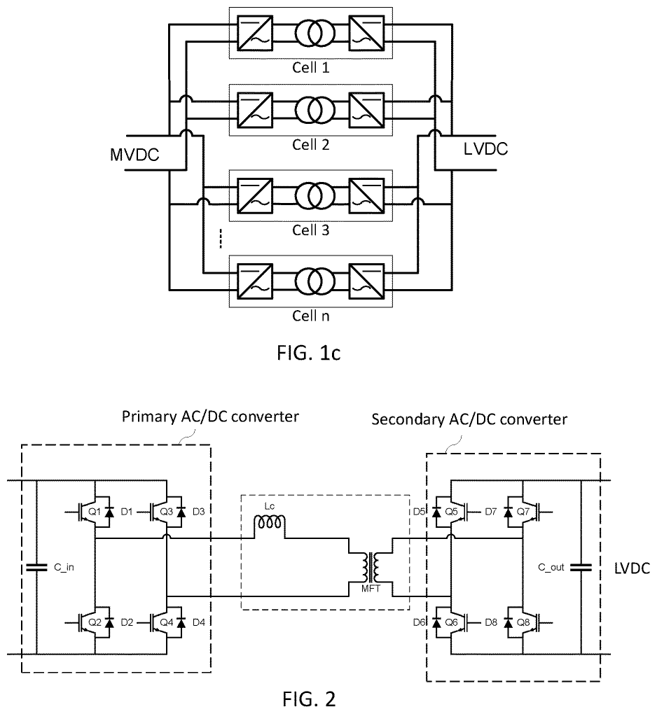

### DETAILED DESCRIPTION OF THE DISCLOSURE

In an embodiment, the present disclosure provides a first controller for a DAB. The first controller comprises:
a primary converter controller, configured to be coupled to a primary converter in the DAB and to control a duty cycle of the primary converter in the DAB based on a difference between a reference value and an output current of a secondary converter in the DAB.

In an embodiment of the first controller, the primary converter controller comprises:
a proportional integral controller, configured to receive the difference between the reference value and a first measurement value of the output current and to generate a phase shift angle based on the difference between the reference value and the first measurement value of the output current, and
a duty cycle control module, configured to be coupled to the primary converter and the proportional integral controller, to receive the phase shift angle and to control the duty cycle based on the phase shift angle.

In an embodiment of the first controller, the controller further comprises a switching frequency control module, configured to be coupled to the duty cycle control module and to generate a switching frequency control signal based on the reference value, wherein the duty cycle control module is configured to receive the switching frequency control signal and to control a switching frequency of the primary converter based on the switching frequency control signal.

In an embodiment of the first controller, the reference value is associated with a current value for a short circuit fault.

In an embodiment of the first controller, the primary converter controller further comprises a computing module configured to be coupled to the secondary converter and to determine a first measurement value of the output current based on a second measurement value of an input current of the secondary converter.

In an embodiment of the first controller, the primary converter controller is activated to control the duty cycle in response to a detection of a short circuit fault (e.g., at output ends of the secondary converter).

In an embodiment of the first controller, the controller further comprises a secondary converter controller, configured to be coupled to the secondary converter and to control the secondary converter based on a direction of an input current of the secondary converter.

In an embodiment of the first controller, the direction of the input current is from a first input end of the secondary converter to a second input end of the secondary converter through a transformer in the DAB. In this embodiment, the secondary converter controller is configured to control the secondary converter to:
activate at least one first switch positioned between the second input end and a positive output end of the secondary converter and at least one second switch positioned between the first input end and a negative output end of the secondary converter, and/or
deactivate at least one third switch positioned between the second input end and the negative output end of the secondary converter and at least one fourth switch positioned between the first input end and the positive output end of the secondary converter.

In an embodiment of the first controller, the transformer is a medium frequency transformer (MFT).

In an embodiment of the first controller, the secondary converter controller is configured to enable the input current to flow through a main channel of at least one transistor activated by the secondary converter controller.

In an embodiment of the first controller, the secondary converter controller comprises:
a direction determining module, configured to generate a direction signal based on a relationship between a value of the input current and 0, and
a control signal generating module, configured to be coupled to the secondary converter, to receive the direction signal and to generate drive signals for controlling at least one switch in the secondary converter based on the direction signal.

In an embodiment of the first controller, the secondary converter controller is activated to control the secondary converter in response to a detection of a short circuit fault (e.g., at output ends of the secondary converter).

In an embodiment, the present disclosure discloses a converter device. The converter device comprises:
a DAB, comprising a primary converter, a transformer and a secondary converter, and
a controller according to any of aforementioned embodiments of the first controller.

In an embodiment, the transformer is an MFT.

In an embodiment of the converter device, at least one switch in the secondary converter comprises at least one metal-oxide-semiconductor field-effect transistor.

In an embodiment, the present disclosure discloses a method for use in a controller (of DAB). The method comprises controlling a duty cycle of the primary converter in a DAB based on a difference between a reference value and an output current of a secondary converter in the DAB.

In an embodiment, the present disclosure provides a second controller for a DAB. The controller comprises a secondary converter controller, configured to be coupled to a secondary converter in the DAB and to control a duty cycle of the secondary converter in the DAB based on a difference between a reference value and an input current of a primary converter in the DAB.

In an embodiment of the second controller, the secondary converter controller comprises:
a proportional integral controller, configured to receive the difference between the reference value and a first measurement value of the input current and to generate a phase shift angle based on the difference between the reference value and the first measurement value of the input current, and
a duty cycle control module, configured to be coupled to the secondary converter and the proportional integral controller, to receive the phase shift angle and to control the duty cycle based on the phase shift angle.

In an embodiment of the second controller, the secondary converter controller further comprises a switching frequency control module, configured to be coupled to the duty cycle control module and to generate a switching frequency control signal based on the reference value, wherein the duty cycle control module is configured to receive the switching frequency control signal and to control a switching frequency of the secondary converter based on the switching frequency control signal.

In an embodiment of the second controller, the reference value is associated with a current value for a short circuit fault (e.g., at input ends of the primary converter).

In an embodiment of the second controller, the secondary converter controller further comprises a computing module configured to be coupled to the primary converter and to determine a first measurement value of the input current based on a second measurement value of an output current of the primary converter.

In an embodiment of the second controller, the secondary converter controller is activated to control the duty cycle in response to a detection of a short circuit fault (e.g., at input ends of the primary converter).

In an embodiment of the second controller, the controller further comprises a primary converter controller, configured to be coupled to the primary converter and to control the primary converter based on a direction of an output current of the primary converter.

In an embodiment of the second controller, the direction of the output current is from a first output end of the primary converter to a second output end of the primary converter through a transformer in the DAB. In this embodiment, the primary converter controller is configured to control the primary converter to:
activate at least one first switch positioned between the second output end and a positive input end of the primary converter and at least one second switch positioned between the first output end and a negative input end of the primary converter, and/or
deactivate at least one third switch positioned between the second output end and the negative input end of the primary converter and at least one fourth switch positioned between the first output end and the positive input end of the primary converter.

In an embodiment of the second controller, the primary converter controller is configured to enable the output current to flow through a main channel of at least one transistor activated by the primary converter controller.

In an embodiment of the second controller, the primary converter controller comprises:
a direction determining module, configured to generate a direction signal based on a relationship between a value of the output current and 0, and
a control signal generating module, configured to be coupled to the primary converter, to receive the direction signal and to generate drive signals for controlling at least one switch in the primary converter based on the direction signal.

In an embodiment of the second controller, the primary converter controller is activated to control the primary converter in response to a detection of a short circuit fault (e.g., at input ends of the primary converter).

In an embodiment, the first controller may be combined with the second controller. For example, the primary converter controller of the first controller may be combined with that of the second controller and/or the secondary converter controller of the first controller may be combined with that of the second controller.

In an embodiment, the present disclosure discloses a converter device. The converter device comprises:
a DAB, comprising a primary converter, a transformer and a secondary converter, and
a controller according to any of aforementioned embodiments of the second controller.

In an embodiment, the transformer is an MFT.

In an embodiment of the converter device, at least one switch in the primary converter comprises at least one metal-oxide-semiconductor field-effect transistor.

In an embodiment, the present disclosure discloses a method for use in a controller (of DAB). The method comprises controlling a duty cycle of the secondary converter in a DAB based on a difference between a reference value and an input current of a primary converter in the DAB.

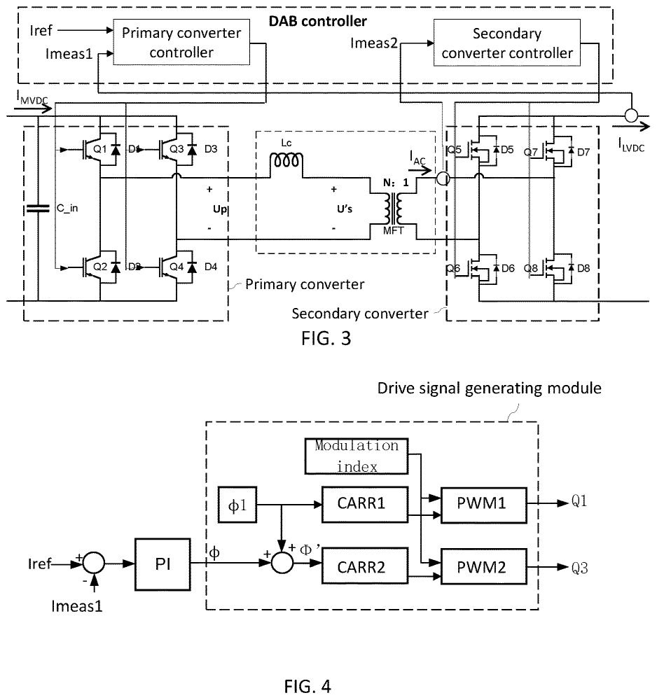

FIG. 3 illustrates a schematic diagram of a converter device (e.g., a solid-state transformer) according to an embodiment of the present disclosure. The converter device shown in FIG. 3 comprises a DAB and a DAB controller. In this embodiment, the DAB comprises a full-bridge two-level converter comprising a primary (AC/DC) converter, an MFT, an inductor Lc and a secondary (AC/DC) converter. Note that the inductor Lc may be a stray inductance of the MFT. The primary converter comprises transistors Q1 to Q4 and diodes D1 to D4. The secondary converter comprises transistors Q5 to Q8 and diodes D5 to D8. Note that the transistors Q5 to Q8 are realized by MOSFETs in this embodiment but are not limited thereto. The DAB controller comprises a primary converter controller and a secondary converter controller. The primary converter controller is configured to control the primary converter (e.g., generate/adjust/control drive signals of Q1 to Q4). The secondary converter controller is configured to control the primary converter (e.g., generate/adjust/control drive signals of Q5 to Q8).

In an embodiment, the primary converter controller controls the primary converter (e.g., Q1 to Q4) via a duty cycle control. Normally, the duty cycle of the primary converter is set to 50%. In this embodiment, the duty cycle of (controlling) the primary converter is controlled by the primary converter controller based on a reference value Iref and an output current ILVDC of the secondary converter. For example, the output current ILVDC may be measured by a current sensor. The measurement value Imeas1 of the output current ILVDC is outputted to the primary converter controller as a basis of controlling the duty cycle of the primary converter.

In an embodiment, the primary converter controller is activated (i.e., to control the duty cycle of the primary converter based on the reference value Iref and an output current ILVDC) in response to a detection of short circuit fault (e.g., at the output(s) of the secondary converter or in LVDC bus or LVDC lines connected to the output(s) of the secondary converter). In an embodiment, the short circuit fault at the output of the secondary converter is called LV short circuit fault. For example, the primary converter controller may be able to detect the LV short circuit fault and is configured to be activated when detecting the LV short circuit fault. As an alternative or in addition, the primary converter controller may be configured to receive an indication signal of whether a LV short circuit fault is detected or occurs. Thus, the primary converter controller is configured to be activated in response the indication signal indicating that the LV short circuit fault is detected or occurs.

In an embodiment, the primary converter controller controls the duty cycle based on a difference between the reference value Iref and the output current ILVDC (i.e., Imeas1). For instance, the duty cycle is controlled/adjusted to be greater if the difference between the reference value and the output current ILVDC is greater, and vice versa.

In an embodiment, the reference value Iref may be associated with a target current for the LV short circuit fault. For example, the reference value Iref may be 1.25 pu (per unit) or 1.25 times the nominal current.

In an embodiment, the reference value Iref may be controlled/adjusted/generated by other circuitry/module (e.g., a controller for the SST comprising the DAB). As an alternative or in addition, the reference value Iref may be a preset/fixed value.

FIG. 4 shows a schematic diagram of a primary converter controller according to an embodiment of the present disclosure. The primary converter controller shown in FIG. 4 comprises a proportional integral controller PI and a drive signal generating module. The proportional integral controller PI is configured to receive the difference between the reference value Iref and the measurement value Imeas1 and to generate a phase-shift angle Φ based on the difference between the reference value Iref and the measurement value Imeas1. The drive signal generating module is configured to be coupled to the proportional integral controller PI and the primary converter, to receive the phase-shift angle Φ and to control the duty cycle of the primary converter based on the phase-shift angle Φ.

Specifically, the difference between the reference value Iref and the measurement value Imeas1 is generated by a comparator. Based on the difference between the reference value Iref and the measurement value Imeas1, the proportional integral controller PI generates the phase-shift angle Φ (e.g., from 0 to π) for a carrier/drive signal of Q3. The drive signal generating module comprises carrier units CARR1 and CARR2 and PWM (pulse width modulation) units PWM1 and PWM2. The CARR1 is configured to receive a phase angle Φ1 for a carrier signal of Q1. For example, the phase angle Φ1 may be 0. The PWM1 is coupled to the CARR1 and configured to generate a drive signal of Q1 based on the carrier signal of Q1. The CARR1 is configured to receive a phase angle Φ′=Φ₁+Φ and generate the carrier signal of Q3 based on the phase angle Φ′ and a modulation index. The PWM2 is coupled to CARR2 and is configured to receive the phase angle Φ′ and to generate the drive signal of Q3 based on the phase angle Φ′ and the modulation index. Note that the drive signals of Q2 and Q4 may be generated based on the drive signals of Q1 and Q3.

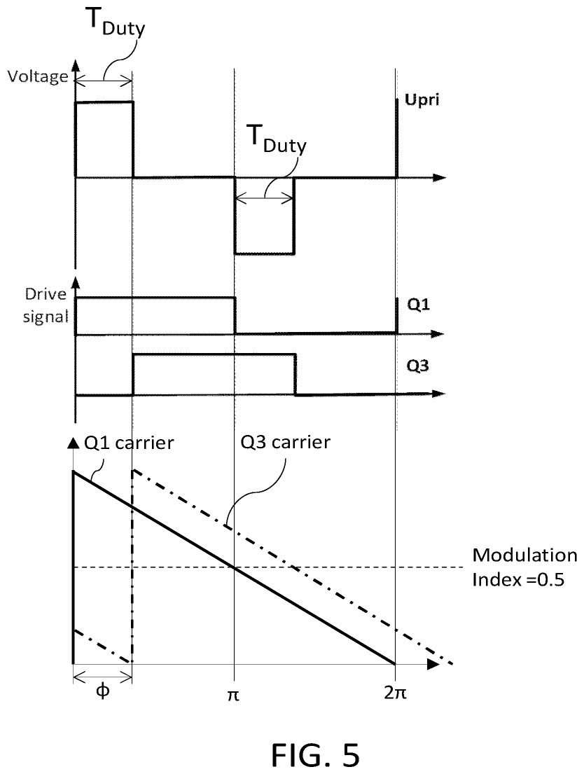

FIG. 5 shows schematic diagram of signals of drive signal generating module according to an embodiment of the present disclosure. As shown in FIG. 5, the phase difference between the carrier signals of Q1 and Q3 is the phase-shift angle Φ. In this embodiment, the modulation index is set as 0.5. Thus, the drive signals of Q1 and Q3 have 50% duty cycle. The period TDUTY of signal Upri for the duty cycle control is determined based on the phase difference between the drive signals of Q1 and Q3, wherein the signal Upri is the voltage applied to a primary winding of the MFT. As can be seen from FIG. 5, the period TDUTY has a positive correlation with the phase-shift angle Φ. That is the duty cycle of the primary converter is controlled/adjusted, by the primary converter controller, based on the phase-shift angle Φ (i.e., the difference between the reference value Iref and the measurement value Imeas1).

Note that the difference between the reference value Iref and the measurement value Imeas1 may be generated/provided by using various types of circuit/element and is not limited to the comparator shown in FIG. 4. In addition, the comparator (or other types of circuit/element) configured to generate the difference between the reference value Iref and the measurement value Imeas1 may be included in the primary converter controller.

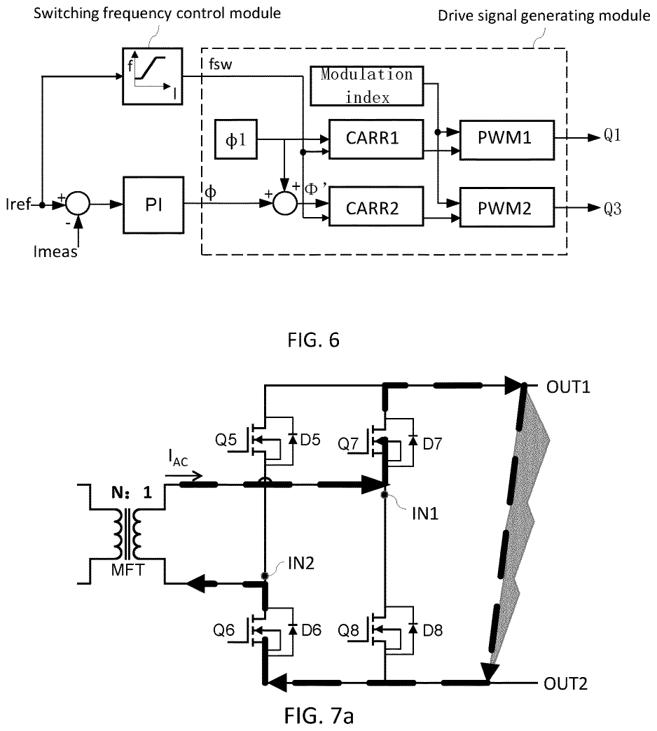

FIG. 6 shows a schematic diagram of a primary converter controller according to an embodiment of the present disclosure. The primary converter controller shown in FIG. 6 is similar to that shown in FIG. 5. Thus, the circuits/elements have the same functionalities and use the same symbols. The primary converter controller shown in FIG. 6 further comprises a switching frequency control module, which is configured to receive the reference value Iref and generate a switched frequency control signal fsw based on the reference Iref. Based on the switched frequency control signal fsw, the drive signal generating module controls/adjusts the switching frequency of the primary converter. For instance, the CARR1 and CARR2 are configured to control/adjust the switching frequency of the carrier signals of Q1 and Q3 based on the switching frequency control signal fsw. The switching frequency of the drive signals of Q1 and Q3 are therefore accordingly adjusted/controlled based on the switching frequency control signal fsw, so as the switching frequency of the primary converter. By using the switching frequency control module, the switching power losses of transistors (e.g., semiconductors) in the primary converter can be reduced.

In an embodiment, the switching frequency of the carrier/drive signals of Q1 and Q3 may have a positive correlation with the reference value Iref. That is, if the reference value Iref is greater, the switching frequency control module controls/adjusts the switching frequency control signal fsw to increase the switching frequency of the carrier/drive signals of Q1 and Q3 (i.e., the switching frequency of the carrier/drive signals of Q1 and Q3 is higher). If the reference value Iref is lower, the switching frequency control module controls/adjusts the switching frequency control signal fsw to decrease the switching frequency of the carrier/drive signals of Q1 and Q3 (i.e., the switching frequency of the carrier/drive signals of Q1 and Q3 is lower).

For the secondary (AC/DC) converter shown in FIG. 3, the secondary converter controller adopts a control of active rectification based on zero-cross judgement of AC current (i.e., IAC) measurement by using a reverse conduction feature of MOSFET in the secondary converter. The control of active rectification makes/enables the short circuit current flow through the main channel of MOSFETs. Because the MOSFETs take responsibility for the most of short-circuit current, the secondary converter does not require additional diodes for the short circuit current. In other words, the D5 to D8 shown in FIG. 3 may comprise only body diodes of the MOSFETs Q5 to Q8. As an alternative or in addition, the D5 to D8 may further comprise additional diodes. In this embodiment, because of the control of active rectification, the design of D5 to D8 does not need to consider the short circuit current.

In an embodiment, the current IAC may be measured by a current sensor. The measurement value Imeas2 of the current IAC is outputted to the secondary converter controller as a basis of controlling the secondary converter.

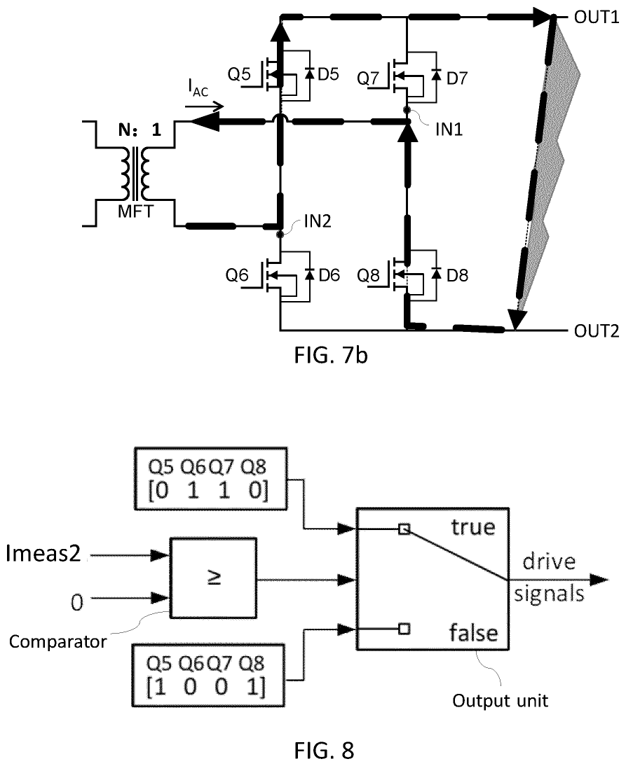

FIGS. 7a and 7b show schematic diagram of secondary converter and MFT according to embodiments of the present disclosure. In FIG. 7a, the current IAC is positive (i.e., greater than 0). Under such a condition, the second converter controller activates/conducts the Q6 and Q7. Because of Q6 and Q7 work in the reverse conduction, the current IAC flow through the main channel of Q6 and Q7. In FIG. 7b, the current IAC is negative (i.e., smaller than 0). Under such a condition, the second converter controller activates/conducts the Q5 and Q8. Because of Q5 and Q8 work in the reverse conduction, the current IAC flow through the main channel of Q5 and Q8.

In an embodiment, the positive current IAC refers to that the current IAC flows from an input end IN2 to another input end IN1 through the MFT.

In an embodiment, the negative current IAC refers to that the current IAC flows from the input end IN1 to another input end IN2 through the MFT.

In an embodiment, at least one of Q5 to Q8 may be replaced by a switch realized by at least one MOSFETs.

FIG. 8 shows a schematic diagram of a secondary converter controller according to an embodiment of the present disclosure. The secondary converter controller in FIG. 8 comprises a comparator and an output unit. The comparator is configured to receive the measurement value Imeas2 of the current IAC and the zero-reference value, to determine whether the measurement value Imeas2 is greater than or equal to 0 and to output the determination result to the output unit. The output unit is coupled to the comparator for receiving the determination result and to output/control/adjust the drive signals of the secondary converter (i.e., Q5 to Q8). If the determination result is true (i.e., the measurement value Imeas2 is greater than or equal to 0), the output unit outputs/controls/adjusts the drive signals of the Q5 to Q8 to be bits [0 1 1 0], respectively. If the determination result is false (i.e., the measurement value Imeas2 is smaller than 0), the output unit outputs bits [1 0 0 1] as the drive signals of the Q5 to Q8, respectively.

Note that the drive signal being the bit ‘0’ refers to that a voltage of the drive signal is lower than a threshold. The drive signal being the bit ‘1’ refers to that a voltage of the drive signal is higher than the threshold. For example, the threshold may be half of the sum of the highest volage and the lowest volage of the secondary converter. In an embodiment, the output unit outputs the drive signal being the bit ‘0’ means that the output unit outputs/controls/adjusts the drive signal to be the lowest voltage of the secondary converter. The output unit outputs the drive signal being the bit ‘1’ means that the output unit outputs/controls/adjusts the drive signal to be the highest voltage of the secondary converter.

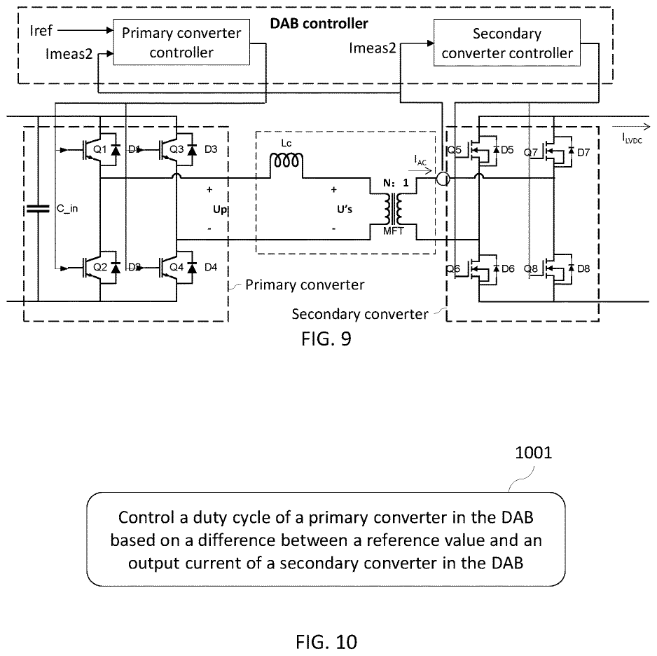

FIG. 9 shows a schematic diagram of a DAB and a DAB controller according to an embodiment of the present disclosure. The embodiment shown in FIG. 9 is similar to the embodiment shown in FIG. 3. Thus, the components/signals have the similar/same functionalities use the same symbols. In comparison with the embodiment shown in FIG. 3, the embodiment shown in FIG. 9 requires only the measurement of the current IAC. In this embodiment, the primary converter controller may further comprise a computing module. The computing module is configured to compute/generate/determine/calculate the value of the current ILVDC based on the Imeas2 (i.e., IAC). The primary converter controller therefore can control the duty cycle of the primary converter based on the computed value. As a result, the circuit/component used for measuring the current ILVDC can be saved.

In an embodiment, the computing module configured to generate/determine/calculate the value of the current ILVDC based on the Imeas2 may not be included in the primary converter controller. For example, the computing module may be realized in other controller circuitry and the primary converter controller is configured to be coupled to the controller circuitry comprising the computing module and to receive the computed value.

In an embodiment, the DAB controller may further comprise circuitry configured to control the primary converter and the secondary converter in situations other than the LV short circuit fault. As an alternative, the primary converter controller and/or the secondary converter controller may also be configured to respectively control the primary converter and/or the secondary converter in situations other than the LV short circuit fault.

In the present disclosure, approaches of duty cycle control and active rectification with reverse conducting transistors (e.g., MOSFETs (metal-oxide-semiconductor field-effect transistors) are proposed, e.g., to ease the situations of high internal current IAC and high output current ILVDC during the steady state of the LV short circuit fault. Note that the approaches of duty cycle control and the active rectification with reverse conducting transistors may be implemented separately. For example, the DAB controller shown in FIG. 3 may comprise only one of the primary converter controller and the secondary converter controller.

Specifically, the DAB controller may turn into a special control mode in response to (a detection of) a LV short circuit fault. In such control mode, the primary and secondary converters are controlled separately. The primary AC/DC converter is controlled by the duty cycle control, wherein the duty cycle is controlled/determined based on the current ILVDC. The secondary converter is controlled by an active rectification based on the direction of the current IAC. The measurements on the current ILVDC and/or the current IAC may be required for controlling the primary converter controller and/or secondary converter. For instance, the measurement of the current ILVDC or IAC may be required for allowing the primary converter controller to control the duty cycle of the primary converter. In addition, the secondary converter controller may need the measurement of the current IAC to determine which switch(es) in the secondary converter need to be activated/conducted.

By using the abovementioned duty cycle control and/or active rectification, the power converter (e.g., DAB) is able to achieve an overcurrent output under a(n) (extremely) low voltage in the steady state (e.g., within a long period) without significant increase in cost.

In an embodiment, the controller of DAB(s) controls the value of duty cycle of the primary converter to achieve a target value of LVDC output current.

In an embodiment, the controller of DAB(s) controls the duty cycle based on the LVDC current measurement.

In an embodiment, the controller of DAB(s) controls drives signals of the secondary converter to make operation current flow through the main channel of semiconductors in the secondary converter.

In an embodiment, the controller of DAB(s) controls the drive signals of the secondary converter based on the current direction of AC current measurement.

In an embodiment, the control functions of the primary converter controller and the secondary controller converter may be mirrored in response to a short-circuit fault at the input(s) of the primary converter, e.g., or in MVDC bus or MVDC lines connected to the input(s) of the primary converter. The short circuit fault may be called MV short circuit fault. In response to the MV short-circuit fault, the secondary controller converter may control the duty cycle of the second converter based on the IMVDC (see, e.g., FIG. 3). In an embodiment, the IMVDC may refer to an input current of the primary coverter. Furthermore, the primary converter controller may control switches (e.g., Q1 to Q4) in the primary converter based on the direction of IAC, to achieve the active rectification. For example, the IAC for the active rectification in the primary converter may be an output current flowing from the primary converter to/through the MFT. In this embodiment, the switches in the primary converter are realized by MOSFETs.

In the present disclosure, input(s) may refer to input end(s).

In the present disclosure, output(s) may refer to output end(s).

FIG. 10 shows a flowchart of a method according to an embodiment of the present disclosure. The method shown in FIG. 10 may be used in or performed by a DAB controller or a processor and comprises the following step:

Step 1001: Control a duty cycle of a primary converter in the DAB based on a difference between a reference value and an output current of a secondary converter in the DAB.

In the embodiment shown in FIG. 10, the DAB controller (e.g., the primary converter controller) is configured to control a duty cycle of a primary converter in the DAB based on a difference between a reference value (e.g., Iref) and an output current (e.g., ILVDC) of a secondary converter in the DAB. Because of the duty cycle control, an internal AC current of the transformer (e.g., MFT) in the DAB can be kept in normal range even if a short circuit fault occurs (e.g., at output(s) of the secondary converter).

In an embodiment, the DAB controller is configured to control the duty cycle of the primary converter by generating a phase shift angle based on the difference between the reference value and a measurement value (e.g., Imeas1) of the output current and controlling the duty cycle based on the phase shift angle.

In an embodiment, the DAB controller may be configured to control a switching frequency of the primary converter based on the reference value.

In an embodiment, the reference value is associated with a (target) current value for a short circuit fault. For example, the reference value may be set based on a current for achieving a protection function for the short circuit fault. For example, the short circuit fault may be an LV short circuit fault at the LVDC side.

In an embodiment, the DAB controller is configured to determine (the measurement value (e.g., Imeas1) of) the output current based on (the measurement value (e.g., Imeas2) of) an input current (e.g., IAC) of the secondary converter.

In an embodiment, the DAB controller is configured to control/adjust the duty cycle of the primary converter in response to a detection of a short circuit fault. For example, the DAB controller may be configured to control/adjust the duty cycle of the primary converter when detecting the short circuit fault. As an alternative or in addition, the DAB controller may be configured to receive an indication signal of whether the short circuit fault is detected or occurs and to control/adjust the duty cycle of the primary converter when the indication signal indicates that the short circuit fault is detected or occurs.

In an embodiment, the DAB controller (e.g., secondary converter controller) is configured to control the secondary converter based on a direction of an input current (e.g., IAC) of the secondary converter. In this embodiment, the secondary converter may be implemented by using MOSFETs.

In an embodiment, based on the direction of the input current, the DAB controller is configured to control the secondary converter to enable the input current to flow through a main channel of at least one switch activated by the secondary converter controller.

In an embodiment, the input current flows/is from a first input end of the secondary converter to a second input end of the secondary converter through a transformer (e.g., MFT) in the DAB. In this embodiment, the DAB controller is configured to activate/conduct at least one first switch positioned between the second input end and a positive output end of the secondary converter and at least one second switch positioned between the first input end and a negative output end of the secondary converter. As an alternative or in addition, the DAB controller is configured to deactivate/disconnect at least one third switch positioned between the second input end and the negative output end of the secondary converter and at least one fourth switch positioned between the first input end and the positive output end of the secondary converter. For example, the first input end may be one of IN1 and IN2 shown in FIGS. 7a and 7b and the second input end may be another one of IN1 and IN2 shown in FIGS. 7a and 7b. The positive output end and the negative output end may be the OUT1 and OUT2 shown in FIGS. 7a and 7b.

In an embodiment, the switch(es) in the secondary converter is realized by using MOSFETs.

In an embodiment, the DAB controller is configured to determine the direction of the input current based on a relationship between a value (e.g., Imeas2) of the input current and 0. The DAB controller then generate drive signals of the secondary converter (e.g., switch(es) in the secondary converter) based on the determination result.

In an embodiment, the DAB controller is configured to control the secondary converter based on the direction of the input current in response to a detection of a LV short circuit fault. For example, the DAB controller may be configured to control the secondary converter based on the direction of the input current when detecting the LV short circuit fault. As an alternative or in addition, the DAB controller may be configured to receive an indication signal of whether the LV short circuit fault is detected or occurs and to control the secondary converter based on the direction of the input current when the indication signal indicates that the LV short circuit fault is detected or occurs.

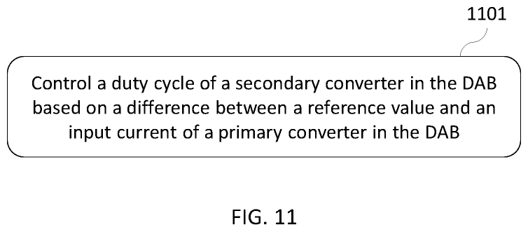

FIG. 11 shows a flowchart of a method according to an embodiment of the present disclosure. The method shown in FIG. 11 may be used in or performed by a DAB controller or a processor and comprises the following step:

Step 1101: Control a duty cycle of a secondary converter in the DAB based on a difference between a reference value and an input current of a primary converter in the DAB.

In the embodiment shown in FIG. 10, the DAB controller (e.g., the secondary converter controller) is configured to control a duty cycle of a secondary converter in the DAB based on a difference between a reference value (e.g., Iref) and an input current (e.g., IMVDC) of a primary converter in the DAB. Because of the duty cycle control, an internal AC current of the transformer (e.g., MFT) in the DAB can be kept in normal range even if a short circuit fault occurs (e.g., at input(s) of the primary converter).

The method shown in FIG. 11 may be similar to the method shown in FIG. 10, thus details of the method shown in FIG. 11 may be referred to aforementioned embodiments. For example, the method shown in FIG. 11 may be derived based on the method shown in FIG. 10 or by mirroring the method shown in FIG. 10. The following aspects refer to particular embodiments of the present disclosure:
1. A first controller for a dual active bridge, DAB, the first controller comprising:
a primary converter controller, configured to be coupled to a primary converter in the DAB and to control a duty cycle of the primary converter in the DAB based on a difference between a reference value and an output current of a secondary converter in the DAB.
2. The first controller of aspect 1, wherein the primary converter controller comprises:
a proportional integral controller, configured to receive the difference between the reference value and a first measurement value of the output current and to generate a phase shift angle based on the difference between the reference value and the first measurement value of the output current, and
a duty cycle control module, configured to be coupled to the primary converter and the proportional integral controller, to receive the phase shift angle and to control the duty cycle based on the phase shift angle.
3. The first controller of aspect 2, further comprising:
a switching frequency control module, configured to be coupled to the duty cycle control module and to generate a switching frequency control signal based on the reference value,
wherein the duty cycle control module is configured to receive the switching frequency control signal and to control a switching frequency of the primary converter based on the switching frequency control signal.
4. The first controller of any of aspects 1 to 3, wherein the reference value is associated with a current value for a short circuit fault.
5. The first controller of any of aspects 1 to 4, wherein the primary converter controller further comprises:
a computing module configured to be coupled to the secondary converter and to determine a first measurement value of the output current based on a second measurement value of an input current of the secondary converter.
6. The first controller of any of aspects 1 to 5, wherein the primary converter controller is activated to control the duty cycle in response to a detection of a short circuit fault.
7. The first controller of any of aspects 1 to 6, further comprising:
a secondary converter controller, configured to be coupled to the secondary converter and to control the secondary converter based on a direction of an input current of the secondary converter.
8. The first controller of aspect 7, wherein the direction of the input current is from a first input end of the secondary converter to a second input end of the secondary converter through a transformer in the DAB, and
wherein the secondary converter controller is configured to control the secondary converter to:
activate at least one first switch positioned between the second input end and a positive output end of the secondary converter and at least one second switch positioned between the first input end and a negative output end of the secondary converter, and/or
deactivate at least one third switch positioned between the second input end and the negative output end of the secondary converter and at least one fourth switch positioned between the first input end and the positive output end of the secondary converter.
9. The first controller of aspect 7 or 8, wherein the secondary converter controller is configured to enable the input current to flow through a main channel of at least one transistor activated by the secondary converter controller.
10. The first controller of any of aspects 7 to 9, wherein the secondary converter controller comprises:
a direction determining module, configured to generate a direction signal based on a relationship between a value of the input current and 0, and
a control signal generating module, configured to be coupled to the secondary converter, to receive the direction signal and to generate drive signals for controlling at least one switch in the secondary converter based on the direction signal.
11. The first controller of any of aspects 7 to 10, wherein the secondary converter controller is activated to control the secondary converter in response to a detection of a short circuit fault.
12. A converter device, comprising:
a dual active bridge, DAB, comprising a primary converter, a transformer and a secondary converter, and
a first controller according to any of aspects 1 to 6.
13. The converter device of aspect 12, wherein the first controller is according to any of aspects 7 to 11, and
wherein at least one switch in the secondary converter comprises at least one metal-oxide-semiconductor field-effect transistor.
14. A method for use in a controller, the method comprising:
controlling a duty cycle of the primary converter in a dual active bridge, DAB, based on a difference between a reference value and an output current of a secondary converter in the DAB.
15. A second controller for a dual active bridge, DAB, the second controller comprising:
a secondary converter controller, configured to be coupled to a secondary converter in the DAB and to control a duty cycle of the secondary converter in the DAB based on a difference between a reference value and an input current of a primary converter in the DAB.
16. The second controller of aspect 15, wherein the secondary converter controller comprises:
a proportional integral controller, configured to receive the difference between the reference value and a first measurement value of the input current and to generate a phase shift angle based on the difference between the reference value and the first measurement value of the input current, and
a duty cycle control module, configured to be coupled to the secondary converter and the proportional integral controller, to receive the phase shift angle and to control the duty cycle based on the phase shift angle.
17. The second controller of aspect 16, further comprising:
a switching frequency control module, configured to be coupled to the duty cycle control module and to generate a switching frequency control signal based on the reference value,
wherein the duty cycle control module is configured to receive the switching frequency control signal and to control a switching frequency of the secondary converter based on the switching frequency control signal.
18. The second controller of any of aspects 15 to 17, wherein the reference value is associated with a current value for a short circuit fault.
19. The second controller of any of aspects 15 to 18, wherein the secondary converter controller further comprises:
a computing module configured to be coupled to the primary converter and to determine a first measurement value of the input current based on a second measurement value of an output current of the primary converter.
20. The second controller of any of aspects 15 to 19, wherein the secondary converter controller is activated to control the duty cycle in response to a detection of a short circuit fault.
21. The second controller of any of aspects 15 to 20, further comprising:
a primary converter controller, configured to be coupled to the primary converter and to control the primary converter based on a direction of an output current of the primary converter.
22. The second controller of aspect 21, wherein the direction of the output current is from a first output end of the primary converter to a second output end of the primary converter through a transformer in the DAB, and
wherein the primary converter controller is configured to control the primary converter to:
activate at least one first switch positioned between the second output end and a positive input end of the primary converter and at least one second switch positioned between the first output end and a negative input end of the primary converter, and/or
deactivate at least one third switch positioned between the second output end and the negative input end of the primary converter and at least one fourth switch positioned between the first output end and the positive input end of the primary converter.
23. The second controller of aspect 21 or 22, wherein the primary converter controller is configured to enable the output current to flow through a main channel of at least one transistor activated by the primary converter controller.
24. The second controller of any of aspects 21 to 23, wherein the primary converter controller comprises:
a direction determining module, configured to generate a direction signal based on a relationship between a value of the output current and 0, and
a control signal generating module, configured to be coupled to the primary converter, to receive the direction signal and to generate drive signals for controlling at least one switch in the primary converter based on the direction signal.
25. The second controller of any of aspects 21 to 24, wherein the primary converter controller is activated to control the primary converter in response to a detection of a short circuit fault.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative methods, logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A first controller for a dual active bridge, DAB, the first controller comprising:
a primary converter controller, configured to be coupled to a primary converter in the DAB and to control a duty cycle of the primary converter in the DAB based on a difference between a reference value and an output current of a secondary converter in the DAB,
wherein the primary converter controller further comprises:
a computing module configured to be coupled to the secondary converter and to determine a first measurement value of the output current based on a second measurement value of an input current of the secondary converter.

2. The first controller of claim 1, wherein the primary converter controller comprises:
a proportional integral controller, configured to receive the difference between the reference value and a first measurement value of the output current and to generate a phase shift angle based on the difference between the reference value and the first measurement value of the output current, and
a duty cycle control module, configured to be coupled to the primary converter and the proportional integral controller, to receive the phase shift angle and to control the duty cycle based on the phase shift angle.

3. The first controller of claim 2, further comprising:
a switching frequency control module, configured to be coupled to the duty cycle control module and to generate a switching frequency control signal based on the reference value,
wherein the duty cycle control module is configured to receive the switching frequency control signal and to control a switching frequency of the primary converter based on the switching frequency control signal.

4. The first controller of claim 1, wherein the reference value is associated with a current value for a short circuit fault.

5. The first controller of claim 1, wherein the primary converter controller further comprises:
a computing module configured to be coupled to the secondary converter and to determine a first measurement value of the output current based on a second measurement value of an input current of the secondary converter.

6. The first controller of claim 1, wherein the primary converter controller is activated to control the duty cycle in response to a detection of a short circuit fault.

7. The first controller of claim 1, further comprising:
a secondary converter controller, configured to be coupled to the secondary converter and to control the secondary converter based on a direction of an input current of the secondary converter.

8. The first controller of claim 7, wherein the direction of the input current is from a first input end of the secondary converter to a second input end of the secondary converter through a transformer in the DAB, and
wherein the secondary converter controller is configured to control the secondary converter to:
activate at least one first switch positioned between the second input end and a positive output end of the secondary converter and at least one second switch positioned between the first input end and a negative output end of the secondary converter, and/or
deactivate at least one third switch positioned between the second input end and the negative output end of the secondary converter and at least one fourth switch positioned between the first input end and the positive output end of the secondary converter.

9. The first controller of claim 7, wherein the secondary converter controller is configured to enable the input current to flow through a main channel of at least one transistor activated by the secondary converter controller.

10. The first controller of claim 7, wherein the secondary converter controller comprises:
a direction determining module, configured to generate a direction signal based on a relationship between a value of the input current and 0, and
a control signal generating module, configured to be coupled to the secondary converter, to receive the direction signal and to generate drive signals for controlling at least one switch in the secondary converter based on the direction signal.

11. The first controller of claim 7, wherein the secondary converter controller is activated to control the secondary converter in response to a detection of a short circuit fault.

12. A converter device, comprising:
a dual active bridge, DAB, comprising a primary converter, a transformer and a secondary converter, and
a first controller according to claim 1.

13. The converter device of claim 12, wherein the first controller further comprises a secondary converter controller, configured to be coupled to the secondary converter and to control the secondary converter based on a direction of an input current of the secondary converter,
wherein at least one switch in the secondary converter comprises at least one metal-oxide-semiconductor field-effect transistor.

14. A method for use in a controller, the method comprising:
controlling a duty cycle of the primary converter in a dual active bridge, DAB, based on a difference between a reference value and an output current of a secondary converter in the DAB.

15. A second controller for a dual active bridge, DAB, the second controller comprising:
a secondary converter controller, configured to be coupled to a secondary converter in the DAB and to control a duty cycle of the secondary converter in the DAB based on a difference between a reference value and an input current of a primary converter in the DAB.

16. The method of claim 14, further comprising:
determining a first measurement value of the output current based on a second measurement value of an input current of the secondary converter.

17. The method of claim 16, further comprising:
receiving the difference between the reference value and a first measurement value of the output current; and
generating and a phase shift angle based on the difference between the reference value and the first measurement value of the output current.

18. The method of claim 17, further comprising:
receiving the phase shift angle and to control the duty cycle based on the phase shift angle.
